(19) United States
(12) Patent Application Publication
(10) Pub. No.: US 2005/0114253 A1
(43) Pub. Date: May 26, 2005

(54) Systems and methods for automated transactions processing

(76) Inventor: James J. Low III, Weston, CT (US)

Correspondence Address: MICHAEL D. BEDNAREK;Shaw Pittman LLP, 1650 Tysons Boulevard, McLean, VA, 22102, US

(21) Appl. No.: 10/718,615

(22) Filed: Nov. 24, 2003

(51) Int. Cl. G06F 17/60

(52) U.S. Cl. 705/37

(57) ABSTRACT

Systems and methods are disclosed for transacting business between multiple parties. The system includes a server used by a business and being accessible by a customer. The server is configured to receive electronically transmitted data from the customer. The system also includes a data mapping system and a filtering system housed on the server. The data mapping system formats the transmitted data into a standard format that is consistent with one or more segments of the business. The filtering system is configured to determine which of the transmitted data can be processed automatically by the one or more segments of the business and which of the transmitted data needs to be manually reviewed by one of the one or more segments of the business.

### BACKGROUND

1. Field of the Invention

The present invention relates to systems and methods for automated data processing. More particularly, the present invention relates to automated systems and methods for data processing and verification of data against individual contracts or treaties.

2. Background of the Invention

Many business processes involve the interaction between a customer's requests and the operation of the business. This simple interaction is typically the first instance of inefficiency and source of errors between what a customer wants and what a business ultimately provides. Thus, any means that would improve the accuracy and efficiency of communication in the customer-to-business interaction would decrease costs and decrease errors.

A common business that handles a large number of customer requests is the insurance industry. Such businesses receive a large number of customer requests and therefore must handle a large number of transactions swiftly and efficiently. However, much error occurs in the interaction between a customer's claim for an incident and the insurance company's ultimate payment to settle the claim. Much overhead is required for the insurance company to handle each claim individually with persons that scrutinize the customer's claim for accuracy and reliability. Thus, insurance companies incur high expenses related to the costs of overhead when each customer claim must be individually considered by a representative of the insurance company before any payment is made to the customer.

In a similar manner, a reinsurance company may have to consider a large number of claims by insurance companies relating to various treaties that the insurance company has with the reinsurance company. In contrast with the customer-to-insurance company interaction, the reinsurance company-to-insurance company interaction is not as manually intensive because much of the system has historically been based on trust.

For example, when an insurance company presents a claim to the reinsurance company, the latter routinely prepares a claims payment, often without conducting the arduous task of fully considering the details of validity and reliability of the claim. The reinsurance company avoids this task even though traditional methods exist for reporting significant claims details for certain reinsurance contracts. These contracts, commonly referred to as “treaties,” often require the insurance company to report claims details on a periodic basis so that the reinsurer can set proper reserves and so that the reinsurer can keep abreast of trends developing in the lines of business covered by the treaty. Customarily, these periodic reports are presented in dense large paper format. However, because of the voluminous amount of data presented in these paper reports, commonly called “bordereaux,” the data cannot be thoroughly and systematically reviewed by the resources generally available in the typical reinsurance company. The reinsurance company thereby “trusts” that the insurance company has presented a claim that conforms to the agreement between the two companies and does not unfairly or unreasonably affect the reinsurance company. Furthermore, any such payment to settle the insurance company's claim is typically delayed by the usual delays associated with the handling of the claim and preparation and transfer of the payment.

Finally, the reinsurance company typically does not conduct a complete accounting of the claim(s) that the insurance company(ies) have presented. Nor is there a complete accounting of the cash flows that have occurred in and out of the reinsurance company relating to various claim(s) from the various insurance policies covered by the treaty contract. Cash flows are typically considered in the aggregate and not specifically with respect to each insurance policy covered by the treaty contract. Thus, there is little assurance, other than a reliance on the insurance company, that a claim is within the metes and bounds of the treaty contract between the two businesses, and that the policy and/or treaty contract limits have not been exceeded.

Thus, even though there has been in place for many years a paper method to provide the reinsurer with the information necessary for proper management of the reinsurer's claims obligations, this method is not effective due to the lack of resources necessary to fully process and analyze the bordereau data. Accordingly, claims data presented on a paper bordereau is an inefficient means for the reinsurance company's routine handling of transactions with its counterparties. Such inefficiencies potentially lead to lost revenue, excess costs, and inaccurate or delayed accounting.

### SUMMARY OF THE INVENTION

The present invention, as described in the exemplary embodiments presented herein, addresses the shortcomings of the efficiencies and inaccuracies that typically occur between two or more parties to a business transaction. Such parties may include individuals, businesses, agencies, or governments. The examples presented throughout this disclosure are directed to interactions between a reinsurance company and its customer, an insurance company. However, this example is merely presented for simplicity and is not intended to be limiting of the present invention.

In one exemplary embodiment of the present invention, a system is disclosed for transacting business. The system includes a server used by a business and being accessible by a customer. The server is configured to receive electronically transmitted data from the customer. The system also includes a data mapping system and a filtering system housed on the server. The data mapping system formats the transmitted data into a standard format that is consistent with one or more segments of the business. The filtering system is configured to determine which of the transmitted data can be processed automatically by the one or more segments of the business and which of the transmitted data needs to be manually reviewed by one of the one or more segments of the business.

In another exemplary embodiment of the present invention, a method is disclosed for transacting business between multiple parties. The method includes receiving electronically transmitted data from a customer, mapping the transmitted data into a standard format that is consistent with one or more segments of the business, and filtering the transmitted data to determine which of the transmitted data can be processed automatically by the one or more segments of the business and which of the transmitted data needs to be manually reviewed by one of the one or more segments of the business.

In yet another exemplary embodiment of the present invention, a method is disclosed for transacting business between a customer and a reinsurer. The method includes receiving bordereau data transmitted electronically from a customer,
mapping the bordereau data into a standard format that is consistent with one or more segments of the reinsurer, and filtering the bordereau data to determine which of the transmitted data can be processed automatically by the one or more segments of the reinsurer and which of the bordereau data needs to be manually reviewed by one of the one or more segments of the reinsurer.

### BRIEF DESCRIPTION OF THE DRAWINGS

FIG. 1 is a flowchart that illustrates an example of a typical process within the reinsurance industry for receiving and processing orders.

FIG. 2A is a flowchart that outlines an exemplary method for automated bordereau processing, according to an embodiment of the present invention.

FIG. 2B is a diagram that illustrates an exemplary system for automated bordereau processing, according to an embodiment of the present invention.

FIG. 3 is a flow diagram that shows another exemplary system and method for automated bordereau processing, according to an embodiment of the present invention.

FIG. 4 is an exemplary data chart of the types of information captured according to an embodiment of the present invention.

### DETAILED DESCRIPTION OF PREFERRED EMBODIMENTS

The systems and methods according to the present invention utilize a universal interface between a customer and a business to facilitate the transactions between two or more parties. The exemplary systems and methods presented herein decrease the time and labor associated with conventional claims- and premium-processing routines, resulting in decreased costs and increased efficiency in transactions between customers and a business. Although the exemplary embodiments described herein are made with reference to the reinsurance industry as an example, the invention is not limited to this type of business. Other types of businesses would benefit from the exemplary systems and methods described herein, and with some known adaptations to conform to the particular business. For example, insurance corporations, government agencies that distribute funds or licenses, or other similar businesses or organizations may benefit from the systems and methods described herein, with expected modifications, apparent to one having skill in the art, to conform to the specific organization.

Exemplary systems and methods according to the present invention increase the ability to efficiently analyze standardized claims bordereaux. Paper bordereaux already follow a limited form of standardization because they generally contain the expected minimum data sets customary to the industry. Some of the functions of the exemplary systems and methods of the present invention include, but are not limited to, automatically identifying erroneously submitted claims within defined categories, automatically processing properly submitted claims, and performing an integrated analysis of claims bordereau and premium bordereau data by underwriting, claims, accounting, and actuarial systems. Some of the benefits to an organization using such exemplary systems and methods include, but are not limited to, increased claims management efficiency, increased accuracy for bulk reserving and payments, reduced costs due to automated processing of eligible reserves and payments, better data for client and account management, a higher degree of accuracy in the accounting of treaty contracts, reduced incidence of the need to reconcile accounts, a new source of quality data for actuarial analysis, better data for risk and portfolio assessment, and reduced costs due to semi-automated processing of the automated option of the exemplary embodiments of the present invention. Other advantages are possible and are apparent to one having ordinary skill in the art.

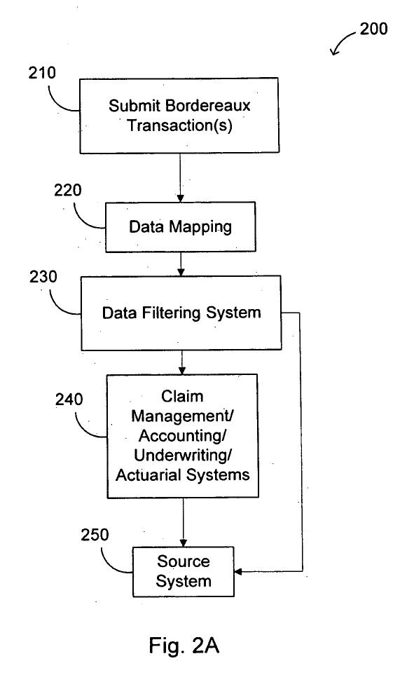

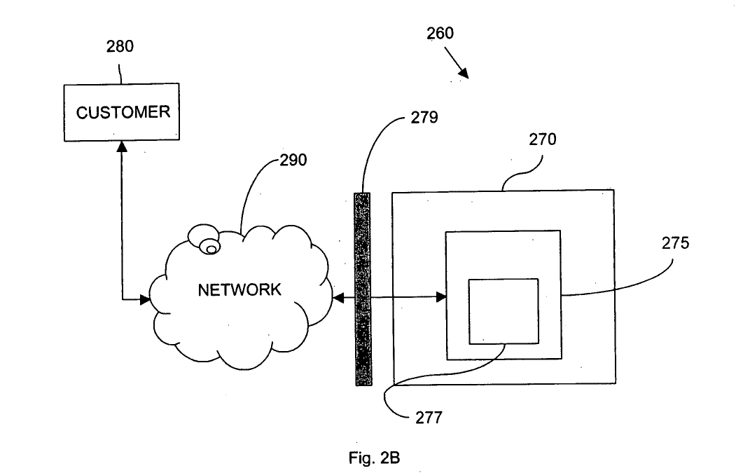

In an exemplary embodiment of the present invention, as seen in FIG. 2A and described below, a system processes claims bordereau data that has been referenced by a client to a particular treaty. On a per-claim basis, the system compares the new bordereau data to the referenced treaty account and claims data existing in the reinsurer's underwriting, accounting, and claims systems. Measurement parameters include, but are not limited to, the proper attachment of claims to the subject treaty by reference to claims dates in comparison to the treaty coverage dates, by reference to line of business characteristics of the claim compared to the lines of business covered by the treaty, by reference to the identity of the insured claimant in comparison to the listing of paid insureds in the premium bordereau filed for the subject treaty, by reference to the identification of reserve/payment changes in comparison to bordereau entries for the same claim on previous bordereaux (such data is retained by the reinsurer on a database) and/or to the reinsurer's claims system having entries for the particular claim, and by reference to claims subject to separate aggregates by reference both to data stored in underwriting systems pertaining to the aggregate limitations of a particular coverage granted by the subject treaty and to the accumulated claims payments made by the reinsurer on claims fitting the limited coverage grant of the subject treaty. These measurement parameters can be adjusted on a per-treaty basis to match marketing, claims, and accounting strategies.

The coverage parameters of the treaty contract are identified and set by the system. Coverage parameters as well as other parameters identified by underwriting, marketing, claims, accounting, and actuarial interests could be manually entered into the system or these could be automatically downloaded from other business systems, or a combination of both processes. Claims data that fits the coverage parameters of the treaty contract will automatically cause the bulk reserves and payments in the reinsurer's claims and accounting systems to be updated. Further, claims data that matches such coverage parameters will contribute to the calculation that determines the amount of premium/claims offset. Conversely, claims data that does not match such coverage parameters is separately identified and a report describing the variance is issued to the appropriate business and/or operations unit. Claims submitted that vary from the expectation of the business will not contribute to the offset calculation for determining the amount of premium/claims due or owed.

Some of the advantages of the exemplary systems and methods according to the present invention as applied to the field of reinsurance will be discussed with specificity, although the present invention is not limited to this field. Traditionally, reinsurance companies have divided and uncoordinated workflow processes, have lacked systems integration, and have undisciplined client strategy regarding minimum bordereau claims data. Accordingly, it is conventionally not possible to certify systematically that a reinsurance company is paying only those claims that are properly ceded to the subject proportional treaty. Although claims audits allow a reinsurance company to capture valuable information on targeted accounts, accounts may not be targeted for audits systematically. Therefore, the audit process as practiced today does not operate as a systematic, portfolio-based solution, and given current resources and operational strategy, the audit process as practiced today can not operate as a systematic, portfolio-based solution. With an integrated, semi-automated solution, a reinsurance company may execute its financial responsibility regarding existing and future bordereaux more systematically, thereby providing more certainty and efficiency.

To address some of the shortcomings of the conventional reinsurance process, the present invention incorporates standardized bordereau claims data requirements into client strategy and implements a systematic process for claims bordereau analysis that operates efficiently, and leverages underwriting, claims, and accounting expertise and systems. The present invention provides these features using a method that is in line with: marketing, accounting, actuarial, underwriting, and claims management strategies; existing expertise; and creating new value. This method increases financial certainty to a higher degree than that which is now possible using conventional methods. For example, only claims covered by the subject treaty are paid; submission of claims bordereau data is less dependent on market cycles so that the quality and quantity of claims data necessary to support financial certainty becomes more regularly available; claims data that matches coverage parameters of the treaty contract is processed into reserving/payments systems more frequently and with more financial certainty; claims data that does not match coverage parameters of the treaty contract is reported as bordereau exceptions for resolution by claims management so that management of claims issues, contractual issues, financial issues, and marketing issues is more efficient. A store of individual claims data accumulated from bordereau claims data is built in order to, among other possibilities, provide the reinsurance underwriter with a new source of high quality data for use in underwriting cedents' claims management practices and to support actuarial analysis to determine and modify the ultimate loss calculation for use in pricing and special portfolio reserving determinations.

In the normal course of today's current business processes, it is only possible to have an extremely low level of financial certainty that the reinsurance company is limiting the payment of claims to its contractual obligation, especially for the type of treaties commonly referred to as “proportional.” A more systematic, integrated approach will provide a robust and thorough means of assessing contractual obligations, resulting in a direct, positive, and significant effect on the bottom line.

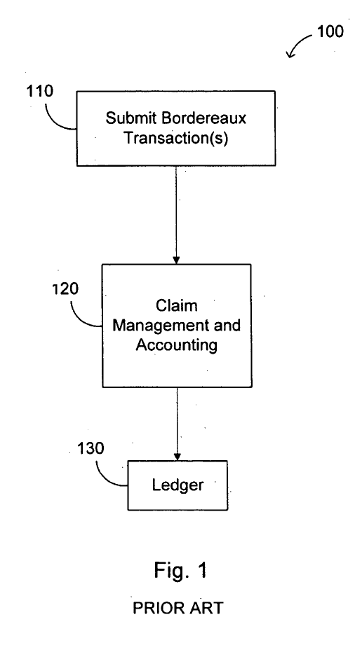

FIG. 1 illustrates, a conventional workflow 100. First, an insurance company submits bordereau transaction 110 to the reinsurer. The bordereaux received by the reinsurer may include premium bordereaux, where the reinsurer receives a list identifying written insurance polices ceded to the subject treaty contract; proportional claims bordereaux, where the reinsurer receives a list identifying claims covered by a proportional or “quote share” treaty contract; and excess claims bordereau, where the reinsurer receives a list identifying claims covered by an “excess” treaty contract. The claims data format may be sent as paper, email, or digitally using an electronic data interface accepted by the industry.

Next, the reinsurer manually enters the data into claims management and accounting systems at 120. This data entry may be performed by separate entities or jointly as a single entity as shown in FIG. 1. In the accounting function, the data may be reviewed for the treaty period and reviewed for indication of incoming premium payments and outgoing claims payments as part of payment/receivables processing. In the claims management function, the data may be reviewed for treaty period, line of business, exclusions, reserve sufficiency, and other claims issues. A periodic review may be performed on the data in order to analyze trends on an account, portfolio, or other basis. Finally, the information is sent to a ledger at 130, where, if the bordereau transaction was a premium bordereau, the ledger would indicate a premium payable and, if the bordereau transaction was a proportional or excess claim bordereau, the ledger would indicate claims payable.

Under current practice, there is typically no minimum standard requirement as to the quality of submitted claims data. Claims data identified as corresponding to proportional treaties is usually not confirmed against proportional premium cession data, so there is no systematic checking to ascertain that the policy under which the claim is made is a policy that has been properly ceded to the subject treaty. Because the typical reinsurer's available resources do not allow for the bordereaux to be systematically analyzed, premium audits generally are not initiated in response to the proportional claims bordereau submission. Indeed, claims audits for proportional treaties are often initiated only for pure underwriting purposes and rarely for claims management or accounting management reasons. Claims are paid on faith without checking against contract terms or premium cession data entered into underwriting management systems. Because the data in claims bordereaux is generally not fully analyzed, analysis of claims development is not done for the purpose of actively managing the reinsurer's liabilities.

The systems and methods of the present invention assist in establishing “best practices” standards for managing claims bordereaux. This includes the establishment of the minimum data standards acceptable for claims bordereaux, the implementation of the optimum work process for the systematic assessment of claims bordereaux, and the accumulation of bordereau claims data. There are several ways to accomplish such objectives within the scope of the invention. One exemplary process 200 is shown in FIG. 2A. In this exemplary embodiment, various objectives are met using automation and business process refinements.

To prepare a useful tool for a given business (e.g., reinsurance company), the variables of the business must be taken into account, and a number of assumptions made with respect to the business. With respect to the example of a reinsurance company, a number of functional assumptions may be made. To assure consistent function for the various processes, data entries are made to underwriting, claims, and accounting management systems on a consistent and disciplined basis. The relevant data fields resident in underwriting, claims, and accounting management systems are accessible to the application. The comparison and measurement parameters are adjustable per treaty. The client presents the minimum bordereau data in the agreed format. The business establishes minimum requirements for bordereau data. Reporting is made per treaty and per business unit.

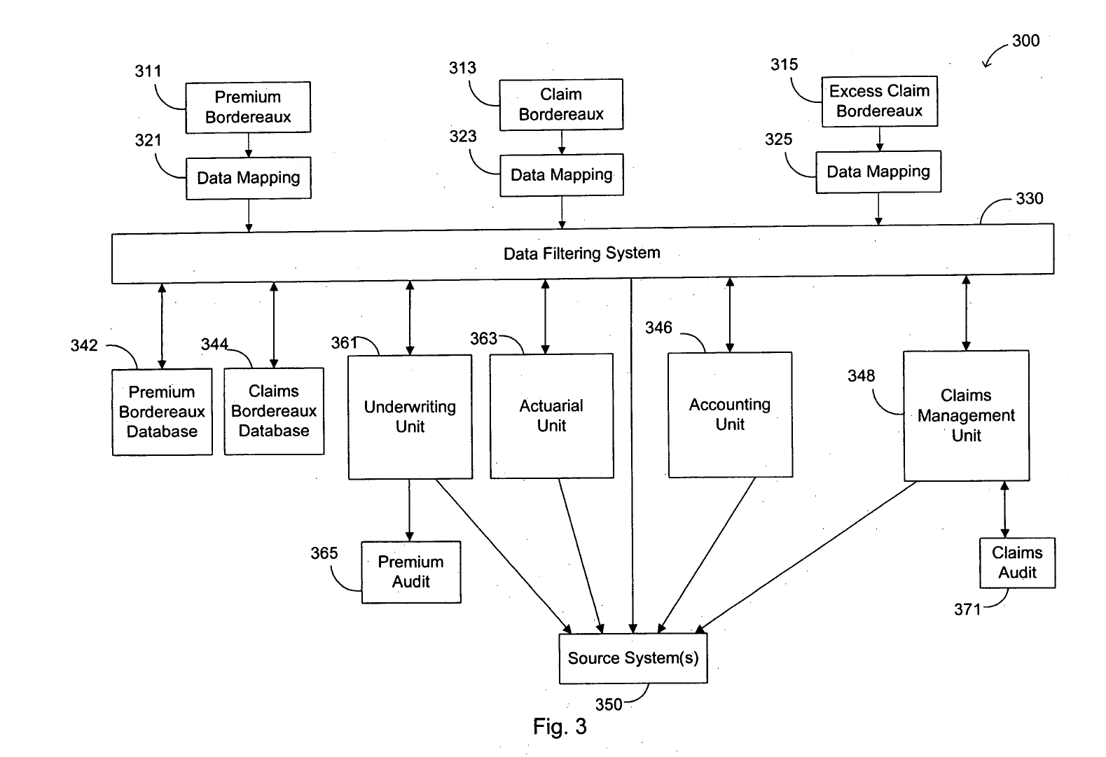

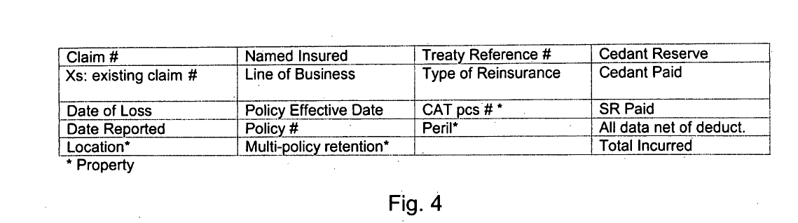

As seen in FIG. 2A, bordereau transactions are submitted electronically (e.g., email, ftp, xml, or other protocols), including the minimum standardized data, at step 210. Data mapping is performed at step 220, where the standardized data is read and stored in appropriate data fields for later use by the reinsurer. At step 220, the data is analyzed and formatted in a manner that is usable by the reinsurer, and may also be mapped differently depending on the type of bordereau that is sent. FIG. 4 shows an exemplary standardized data arrangement for a claims bordereau that may be submitted by an insurance company. This will be discussed further in relation to FIG. 3. It is understood that the data submitted from an insurance company may take any number of forms so long as the minimum standardized data is provided.

The data is submitted to an application suite or filter system at step 230. The filter system compares the submitted data with previously stored information in one or more of claim management, accounting, underwriting, or actuarial systems at step 240. It is understood that a single entity may control one or more of these systems as shown, or that these functions may be spread across two or more entities.

Claims that do not fit coverage expectations are not immediately processed and do not contribute to premium/claims offset calculation. Claims fitting coverage expectations, but flagged for monitoring purposes, are processed for payment/reserving. Finally, all bordereau transactions fitting coverage expectations are updated in a source system at step 250. Alternatively, as shown, the data may be entered directly from the filter system at step 230 into the appropriate source system at step 250 if there are no discrepancies with the data submitted. The source system may be a ledger for the recording of all bookings and payments or any other record tracking system utilized by the claims management, accounting, underwriting, and actuarial systems.

FIG. 2B is a schematic diagram showing an exemplary system 260 of an embodiment of invention. System 260 of the invention includes server 275 and processing engine 277. Server 275 can include one server or a network of servers. Server 275 is associated with business 270 (e.g., a reinsurance business). For example, server 275 can be owned, operated, or otherwise maintained by or on behalf of business 270. Server 275 is associated with processing engine 277. Processing engine 277 is associated with a processor that is configured to execute processes and methods in accordance with the present invention as described herein. For example, processing engine 277 may execute various processes required for data mapping and data filtering.

Server 275 is accessible to one or more customers 280 over network 290. A customer 280 is, for example, an insurer. Firewall 279 of server 275 is provided to prevent unauthorized access to server 275.

Customer 280 and business 270 can communicate with each other via network 290. Network 290 can be any known communications network. Preferably, network 290 is the Internet. In the context of the reinsurance industry, customer 280 is an insurance company that sells insurance policies to insured parties. Business 270 is a reinsurer that provides customer 280 with reinsurance services associated with the insurance policies of customer 280.

For example, when customer 280 (e.g., an insurance company) provides business 270 with bordereau data, the data flows through application modules associated with server 275. For convenience, the processes associated with the applications modules are referred to as data mapping and data filtering processes.

The data is first validated technically to ensure that the input data provided by customer 280 fits the minimum data quality requirements. This validation of the data quality can include, for example, checking for correct syntax, confirming that each value of the input data is within a predefined (context-less) range, ensuring that basic relationships between values in the request are correct (e.g., DATE1 is before DATE5), and so on.

Next, modules/functions associated with server 275 can concentrate on business validation rules for several processes for the data mapping and data filtering. Filter rules or “business checks” may also be provided to determine afterwards whether manual intervention by the business is needed.

Other applications may also reside on server 275 to support the various business segments (i.e., accounting, claims management, actuarial, and underwriting). For example, respective source systems, such as the ledger for the accounting unit, may be provided on server 275.

There are a number of qualitative benefits resulting from the exemplary embodiment shown in FIG. 2A. For example, there is value in the standardization of claims data. By standardizing a reinsurance company's requirements for minimal bordereau claims data, business governance is improved significantly. Marketing and underwriting units are able to communicate to clients a consistent market posture for the reinsurance company. The reinsurance company is able to more efficiently certify payment for covered claims only and is able to assess contract and portfolio performance more accurately. Establishing benchmarks for bordereau data reduces the impact on the quality and quantity of data submission due to market cycles. A higher level of data quality is available for business steering. In addition, there is parallel market activity (e.g., ACORD), which seeks to establish industry standards for minimum claims data sets.

There is value in automatically filtering claims bordereau data. Like a rating or pricing tool, the present invention may filter and evaluate data against benchmarks. For example, it is possible to automatically identify which claims are eligible for further automated processing and which claims require human attention. Automatically validating bordereaux against claims-relevant benchmarks establishes and standardizes the work process for line-item assessment of every claims bordereau. The long-term costs are lower than the expanded payroll costs otherwise necessary to fully review every claims bordereau. It also allows the reinsurer to direct resource allocation toward those claims issues requiring professional claims management and to compare relevant data maintained in underwriting, claims, and accounting management systems, thus further leveraging those investments. Measuring bordereau claims against benchmarks allows for a new certainty that only properly covered claims are systematically processed for payment.

There is also value in analyzing data that is not currently captured. By systematically capturing data not conventionally analyzed by a reinsurance company and placing it automatically in a dedicated database, the ability of claims management to monitor the significant developments of any claim and to more accurately assess reserves is increased. For underwriting management, capturing this data allows better analyses of a cedent's claims management practices. For the actuaries, systematically accumulating this data contributes significantly to comprehensive actuarial analyses of a portfolio's ultimate loss. For accounting, capturing this data on a per-claim basis allows increased certainty that payments made are contractually appropriate.

Using the above process allows automatic updating of related systems with eligible claims bordereau data. Exemplary applications (e.g., software) of the present invention can identify claims that are properly submitted and within expectation so that the reserve and payment changes for only these claims are processed into the appropriate systems. By automatically processing payment and reserving data, the present invention establishes greater coordination between claims and accounting units regarding set-off matters, thereby improving account management. The automated processing of payment and the reserving of data also increase administrative efficiency at a lower employee resource cost because processed payment and reserve data is downloaded automatically into claims systems and/or accounting systems, thus further leveraging those investments.

Another value of this process is automation. Addressing concerns of business continuity, transaction data is saved in an easily accessed format (e.g., digital). With respect to security, transaction data is placed into secure systems. And regarding corporate governance, transaction data is processed in a standardized way so that it is transparently accessible to authorized people. Additional benefits include savings on claims payments; access to a central claims bordereau database; management processes in place for professional review of claims bordereaux; incorporation of premium cession data in claims management assessment; assurance of prompt reporting by comparison to claims data maintained in claims management systems; and automated reconciling of bordereau cash call accounts.

Another exemplary embodiment of an automated system 300 for implementing the same or similar processes as those described above is shown in FIG. 3. As shown, depending on the type of bordereau transaction, the data submitted may undergo different processing. An insurance company may submit one or more of premium bordereaux 311, claim bordereaux 313 (such as proportional claim bordereaux), and excess claim bordereaux 315 to the reinsurer. Premium bordereau data is the submission of risks that are to be assigned to a new treaty or an existing treaty. This data is submitted electronically so that it is readily processed.

As mentioned earlier, FIG. 4 shows an exemplary standardized data arrangement for a claims bordereau that may be submitted by an insurance company. The type of standardized data may vary depending on the type of bordereau submitted, and the examples listed are not intended to be exclusive or limiting of the data submitted, but merely exemplary. For example, the standardized data for a claims bordereau may include the claim number, name of the insured, treaty reference, line of business, policy number, and policy effective date, among others. If the insured item is real estate, the standardized data may also include the location of the property. For an excess claim bordereau, the standardized data may be similar to the claim bordereau including the amount of the underlying policy that has been exceeded. For a premium bordereau, the standardized data may include the treaty with which it is associated, the underlying deductible, the name of the insured, and the location of property, if specified separately. The premium bordereau typically would not have a claim reference.

Returning to FIG. 3, the data undergoes data mapping at step 321, 323, or 325, depending on the type of bordereau transaction. It is understood that the data mapping can be performed by a single process so long as it is configured to distinguish between the different types of bordereaux being submitted.

Regardless of the type of bordereau submitted, the data is transmitted to a filter system 330. The data is either stored in a premium bordereau database 342 or a claims bordereau database 344 and remains accessible through the filter system 330 or via a direct connection (not shown).

The data in databases 342 and 344 are used by the underwriting unit 361 and the actuarial unit 363. In the exemplary embodiment, the data in claims bordereaux database 344 is used by the actuarial unit 363, while the data from the underwriting unit 361 is available for premium auditing 365. It is also possible for each of the business units (i.e., claims management, accounting, underwriting, and actuarial units) to access the databases through the filtering system 330.

Next, the bordereau data from each of the premium, claim, and excess claim bordereaux in the filtering system 330 is compared to the data in either the accounting unit 346 or the claims management unit 348. In this exemplary embodiment, the accounting unit 346 tracks all information pertaining to payables from the proportional claims bordereaux and all information pertaining to receivables from the premium bordereaux. The claims management unit 348 reviews the data from proportional claims bordereaux and excess claims bordereaux for such items within treaty period, within line of business, any exclusions, reserve sufficiency, and other claims issues. The claims management unit 348 also updates the filtering system 330 if there are any claim exceptions.

After updating the data in the accounting unit 346, the data is transmitted to source system 350. In the case of the accounting unit 346, the source system 350 may be a ledger.

After updating the data in the claims management unit 348, the data is transmitted to the source system 350. The source system may be a claims system that shares information with the ledger. A claims audit function 371 may also be provided to review data stored by the claims management unit 348 to determine whether a submitted claim complies with its corresponding treaty.

The underwriting unit 361, as described elsewhere, reviews premium bordereau data identified as exceptions by the exemplary embodiment to determine whether to accept a risk under an existing treaty or a new treaty. A premium audit 365 may be performed to determine whether a submitted risk belongs to an existing treaty.

The underwriting support traditionally provided by the actuarial unit 363 for risk pricing is enhanced by efficiency gains due to the increased quality of standardized premium and claim bordereau information made available to the actuarial unit 363. By analyzing data accumulated in databases 342 and 344, the actuarial unit 363 can determine pricing trends and ultimate losses for particular lines of business with larger amounts of data provided at a more granular level than is usual today. Better pricing efficiencies bring competitive advantage to the underwriting unit 361.

In addition to assessing the level of risk with a submitted premium bordereau, the actuarial unit 363 determines what a particular treaty will ultimately cost the reinsurer. This information is used to set aside special reserves that are not allocated to any claims but are available to cover these future costs. The data stored in the premium and claims databases 342 and 344 are useful in determining how much special reserves to carry. Finally, the actuarial unit 363 may also assess risks to the organization as a whole.

For the above reasons, the actuarial unit 363 and underwriting unit 361 may also provide information to be used and shared by the source systems 350.

The exemplary embodiment of automated system 300 has the same advantages as described above for automated system 200 (FIG. 2A) and is provided to show one embodiment for implementing the system where the accounting, claims management, underwriting, and actuarial systems are controlled by separate units.

A further advantage of the exemplary systems and methods of the present invention is the coordination of all parties to a transaction. Such an advantage may be realized, for example, from: combining expertise and data from claims, underwriting, and accounting management systems to implement the optimum workflow for processing bordereau claims data; accumulating claims bordereau data in a way accessible to stakeholders; and providing greater financial certainty to the business.

Another advantage of the exemplary systems and methods of the present invention is the efficient management of claims. Such an advantage may be realized when, for example: the acceptable minimum claims data is established for digitally transmitting claims bordereaux by relying on the industry customs and practices influenced by market developments (e.g., the ACORD messaging standards); accommodating line of business differences; assuring prompt reporting of claims by comparing bordereau entries to individual claim files maintained in claims management systems; improving the process for reconciling bordereau cash call accounts; maximizing the value of additional data in electronic form; and measuring the variance of claims data against certain thresholds such as the proper attachment of claims to the referenced treaty, identification of reserve/payment changes, and claims for certain lines of business that are subject to separate aggregates.

A number of variance measurement parameters may be taken into consideration. Such parameters may be measured by, for example: aggregating certain claims to determine limits remaining per treaty; identifying claims that exceed treaty limits; identifying claims that fall outside policy effective dates; identifying claims that fall outside the treaty period; identifying claims that fall outside the treaty coverage; identifying client reserves beyond a threshold of contractual significance as may be previously entered in another business system; identifying client reserve changes beyond a threshold of contractual significance; identifying claims payments beyond a threshold significance matched to a business system entry; identifying an incurred loss beyond a threshold of contractual significance as may be previously entered in another business system; identifying incurred loss changes beyond a threshold of contractual significance; identifying claims for certain lines of business that are subject to separate limits; and identifying bordereau charges that do or do not apply to the subject contract.

Another advantage of the exemplary systems and methods according to the present invention relates to the management of accounting. For example, by using exemplary embodiments of the present invention, a reinsurance company may improve its process for reconciling bordereau cash call accounts and may streamline work processes involved with claims bordereaux. An efficiency of the exemplary system can be a significant reduction in items requiring reconciliation.

Another advantage of the exemplary systems and methods according to the present invention relates to the management of underwriting. For example, by using exemplary embodiments of the present invention, a reinsurance company may improve its process for assessing the underwriting risk and claims management risk of the insurance company.

Another advantage of the exemplary systems and methods according to the present invention relates to actuarial analysis. For example, by using exemplary embodiments of the present invention, a reinsurance company may improve its process for establishing line of business risk profiles based on data accumulated as a result of the present invention, thereby improving the accuracy of technical pricing and the ultimate net loss of a portfolio.

Another advantage of the exemplary systems and methods according to the present invention relates to the management of claims. For example, by using exemplary embodiments of the present invention, a reinsurance company may improve its process for identifying claim activity that requires particular attention.

Another advantage of the exemplary systems and methods according to the present invention relates to the management of the client relationship. For example, by using exemplary embodiments of the present invention, a reinsurance company may improve its process for using account data to assess and refine client services. Other areas of improvement are also possible and apparent to one having ordinary skill in the art.

In use, an exemplary method of the present invention proceeds as follows, although the invention is not limited to the herein described exemplary method. The process begins when a client submits a claims bordereau as a spreadsheet file (e.g., ASC or Excel™) containing the minimum acceptable data set. The data is downloaded into an analysis tool that processes the data on a per-treaty basis according to certain measurement parameters in comparison to data existing in underwriting, claims, and accounting management systems. Claims data that is at variance with data previously entered into claims and/or accounting management systems as compared to reserve and/or payment changes, but otherwise meeting expectations, can be further processed automatically to the claims and/or accounting management systems. Claims data at variance with expectations is itemized in a variance report. The application makes queries to underwriting, claims, and accounting management systems as necessary.

The exemplary systems and methods described above according to the present invention have many advantages. One such advantage is that the interaction between the customer and the business is automated. This automation reduces the costs and errors associated with non-automated processes, such as, for example, person-to-person communications. Furthermore, all transactions are electronically recorded, thus reducing the potential for miscommunication between live parties.

Another unique advantage of the systems and methods according to the present invention is their ability for rapid expansion. Although the present invention is presented with very specific examples of procedures that are most commonly encountered in the reinsurance business, the invention is not restricted to this type of business. Any business that could benefit from automating transactional encounters between a business and its customers would benefit from the use of this invention. The parameters, options, and paths shown in the exemplary embodiments of the figures could be programmed to account for the specific requirements and unique business options of any other business.

In describing representative embodiments of the invention, the specification may have presented the method and/or process of the invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the invention should not be limited to the performance of their steps in the order written, and one skilled in the art can readily appreciate that the sequences may be varied and still remain within the spirit and scope of the invention.

The foregoing disclosure of the embodiments of the invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

The systems and methods of the present invention are designed to be user-friendly and readily accessible to a customer with minimal manual intervention by a business utilizing such systems and/or methods. Thus, a non-limiting means of providing access to the systems and/or methods of the present invention is through the Internet. A customer may readily submit bordereau data through the Internet at any time and from any place in the world that allows Internet access. Such access may either be provided through hardwire means or remotely. This increased flexibility and lack of constraint with respect to time and place for data submission provides a tremendous benefit to the customer. Likewise, such flexibility offered to the customer provides the business with an increased customer base of those who are attracted to such flexibility.

1. A system for transacting business between multiple parties, the system comprising:
a server used by a business and being accessible by a customer, the server being configured to receive electronically transmitted data from the customer;
a data mapping system housed on the server, wherein the data mapping system formats the transmitted data into a standard format that is consistent with one or more segments of the business; and
a filtering system housed on the server, wherein the filtering system is configured to determine which of the transmitted data can be processed automatically by the one or more segments of the business and which of the transmitted data needs to be manually reviewed by one of the one or more segments of the business.

2. The system of claim 1, wherein the standard format is predetermined by the business.

3. The system of claim 1, wherein the standard format is universal for all businesses in an industry in which the business operates.

4. The system of claim 1, wherein the transmitted data that is entered is further processed if it is manually reviewed by one of the one or more segments of the business.

5. The system of claim 1, wherein the one or more segments of the business includes at least one of the following:
accounting, claims management, underwriting, and actuarial.

6. The system of claim 1, wherein the server is accessible through the Internet.

7. The system of claim 1, wherein the server is remotely accessible.

8. A method for transacting business between multiple parties, the method comprising:
receiving at a business electronically transmitted data from a customer;
mapping the transmitted data into a standard format that is consistent with one or more segments of the business; and
filtering the transmitted data to determine which of the transmitted data can be processed automatically by the one or more segments of the business and which of the transmitted data needs to be manually reviewed by one of the one or more segments of the business.

9. The method of claim 8, wherein the standard format is predetermined by the business.

10. The method of claim 8, wherein the standard format is universal for all businesses in an industry in which the business operates.

11. The method of claim 8, wherein the transmitted data that is entered is further processed if it is manually reviewed by one of the one or more segments of the business.

12. The method of claim 8, wherein the one or more segments of the business includes at least one of the following:
accounting, claims management, underwriting, and actuarial.

13. The method of claim 8, wherein the transmitted data relates to an insurance claim.

14. A method for transacting business between a customer and a reinsurer, the method comprising:
receiving bordereau data transmitted electronically from a customer;
mapping the bordereau data into a standard format that is consistent with one or more segments of the reinsurer; and
filtering the bordereau data to determine which of the transmitted data can be processed automatically by the one or more segments of the reinsurer and which of the bordereau data needs to be manually reviewed by one of the one or more segments of the reinsurer.

15. The method according to claim 14, further comprising communicating the bordereau data electronically to a common ledger.

16. The method according to claim 14, wherein the bordereau data is one of claims bordereau data and excess claims bordereau data, and the method further comprises conducting a claims audit of the bordereau data.

17. The method according to claim 14, wherein the bordereau data includes claims bordereau data and excess claims data, and wherein filtering the bordereau data includes automatically comparing the standardized claims bordereau and the standardized excess claims bordereau with benchmark data.

18. The method according to claim 17, wherein the benchmark data is stored in one of an accounting system and a claims management system.

19. The method according to claim 14, wherein the bordereau data is premium bordereau data, and the method further comprises conducting a premium audit of the bordereau data.

20. The method according to claim 14, wherein the bordereau data is premium bordereau data, and the filtering the bordereau data includes automatically comparing the bordereau data with benchmark data.

21. The method according to claim 17, wherein the benchmark data is stored in one of an underwriting system and an actuarial system.
